(19) United States
(12) Patent Application Publication
(10) Pub. No.: US 2026/0370268 A1
(43) Pub. Date: Nov. 19, 2026

(54) DISTRIBUTED MIMO CALIBRATION

(71) Applicant: Samsung Electronics Co., Ltd., Suwon-si (KR)

(72) Inventors: R A Nadisanka Perera Rupasinghe, McKinney, TX (US); Yang Li, Plano, TX (US); Vishnu Vardhan Ratnam, Frisco, TX (US)

(21) Appl. No.: 19/667,451

(22) Filed: May 4, 2026

Related U.S. Application Data
(60) Provisional application No. 63/805,034, filed on May 13, 2025.

(51) Int. Cl. H04B 7/0413; H04B 7/024

(52) U.S. Cl. CPC H04B 7/0413; H04B 7/024

(57) ABSTRACT

Methods and apparatuses for a distributed MIMO calibration in a wireless communication system. The method of a BS comprises: identifying first signals comprising a first set of the first signals and a second set of the first signals; identifying second signals comprising a first set of the second signals and a second set of the second signals; calibrating, based on the first signals and the second signals, a set of parameters for a distributed MIMO to transmit downlink signals; and transmitting, to a UE, the downlink signals, wherein a first set of antenna ports includes the reference antenna port and the antenna ports include in the network entity and a second set of antenna ports includes the reference antenna port and the antenna ports included in the neighbor network entity.

### CROSS-REFERENCE TO RELATED APPLICATIONS AND CLAIM OF PRIORITY

The present application claims priority to U.S. Provisional Patent Application No. 63/805,034, filed on May 13, 2025. The contents of the above-identified patent documents are incorporated herein by reference.

### TECHNICAL FIELD

The present disclosure relates generally to wireless communication systems and, more specifically, the present disclosure relates to a distributed multiple input multiple output (MIMO) calibration in a wireless communication system.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to wireless communication systems and, more specifically, the present disclosure relates to a distributed MIMO calibration in a wireless communication system.

In one embodiment, a network entity in a wireless communication system is provided. The network entity comprises a processor configured to: identify first signals comprising a first set of the first signals and a second set of the first signals, wherein: the first set of the first signals comprises a reference signal (RS) received from a reference antenna port included in the network entity and channel estimate identified from antenna ports included in a neighbor network entity, and the second set of the first signals comprises an RS received from the antenna ports included in the neighbor network entity and channel estimate identified from the reference antenna port included in the network entity, identify second signals comprising a first set of the second signals and a second set of the second signals, wherein: the first set of the second signals comprises an RS received from a reference antenna port included in the neighbor network entity and channel estimate identified from antenna ports included in the network entity, and the second set of the second signals comprises an RS received from the antenna ports included in the network entity and channel estimate identified from the reference antenna port included in the neighbor network entity, calibrate, based on the first signals and the second signals, a set of parameters for a distributed multi-input multi-output (MIMO) to transmit downlink signals. The network entity further comprises a transceiver operably coupled to the processor, the transceiver configured to transmit, to a user equipment (UE), the downlink signals, wherein a first set of antenna ports includes the reference antenna port and the antenna ports include in the network entity and a second set of antenna ports includes the reference antenna port and the antenna ports included in the neighbor network entity.

In another embodiment, a method of a network entity in a wireless communication system is provided. The method comprises: identifying first signals comprising a first set of the first signals and a second set of the first signals, wherein: the first set of the first signals comprises an RS received from a reference antenna port included in the network entity and channel estimate identified from antenna ports included in a neighbor network entity, and the second set of the first signals comprises an RS received from the antenna ports included in the neighbor network entity and channel estimate identified from the reference antenna port included in the network entity; identifying second signals comprising a first set of the second signals and a second set of the second signals, wherein: the first set of the second signals comprises an RS received from a reference antenna port included in the neighbor network entity and channel estimate identified from antenna ports included in the network entity, and the second set of the second signals comprises an RS received from the antenna ports included in the network entity and channel estimate identified from the reference antenna port included in the neighbor network entity; calibrating, based on the first signals and the second signals, a set of parameters for a distributed MIMO to transmit downlink signals; and transmitting, to a UE, the downlink signals, wherein a first set of antenna ports includes the reference antenna port and the antenna ports include in the network entity and a second set of antenna ports includes the reference antenna port and the antenna ports included in the neighbor network entity.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of a wireless network according to various embodiments of the present disclosure;

FIG. 2 illustrates an example of BS according to various embodiments of the present disclosure;

FIG. 3 illustrates an example of UE according to various embodiments of the present disclosure;

FIGS. 4 and 5 illustrate examples of wireless transmit and receive paths according to various embodiments of the present disclosure;

FIG. 6 illustrates an example of antenna structure according to various embodiments of the present disclosure;

FIG. 7 illustrates an example of a transmission and reception of pilot according to various embodiments of the present disclosure;

FIG. 8 illustrates an example of coherent JT to a UE from two RUs according to various embodiments of the present disclosure; and

FIG. 9 illustrates a flowchart of a BS method for a distributed MIMO calibration according to various embodiments of the present disclosure.

### DETAILED DESCRIPTION

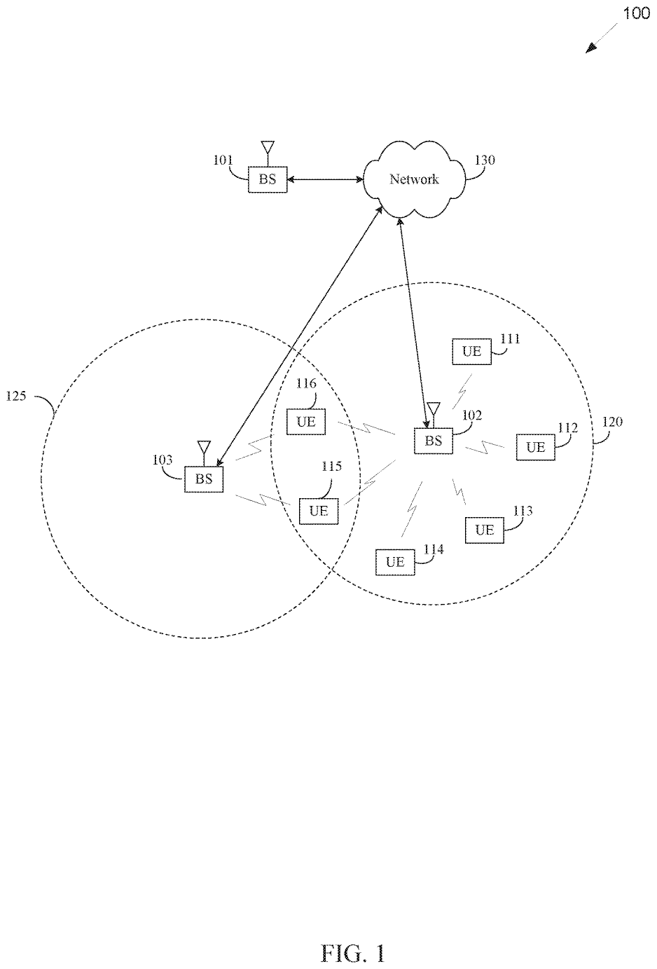

FIG. 1 through FIG. 9, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive MIMO, full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to various embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a BS 101 (e.g., base station, BS), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6G base station (aNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof, to generate any signals and/or information supporting a distributed MIMO calibration in a wireless communication system, at BSs 101-103, in a wireless communication system. In certain embodiments, and one or more of the BSs 101-103 includes circuitry, programing, or a combination thereof, to support a distributed MIMO calibration in a wireless communication system.

Although FIG. 1 illustrates one example of a wireless network, various changes may be made to FIG. 1. For example, the wireless network could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

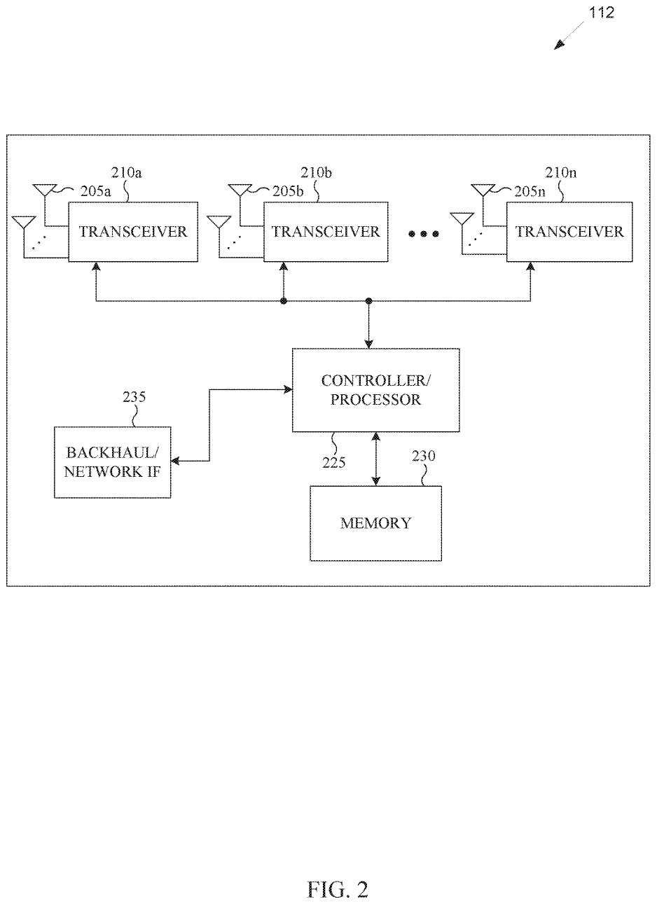

FIG. 2 illustrates an example BS 102 according to various embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as processes to support any operation of a distributed MIMO calibration in a wireless communication system. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a wireless communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

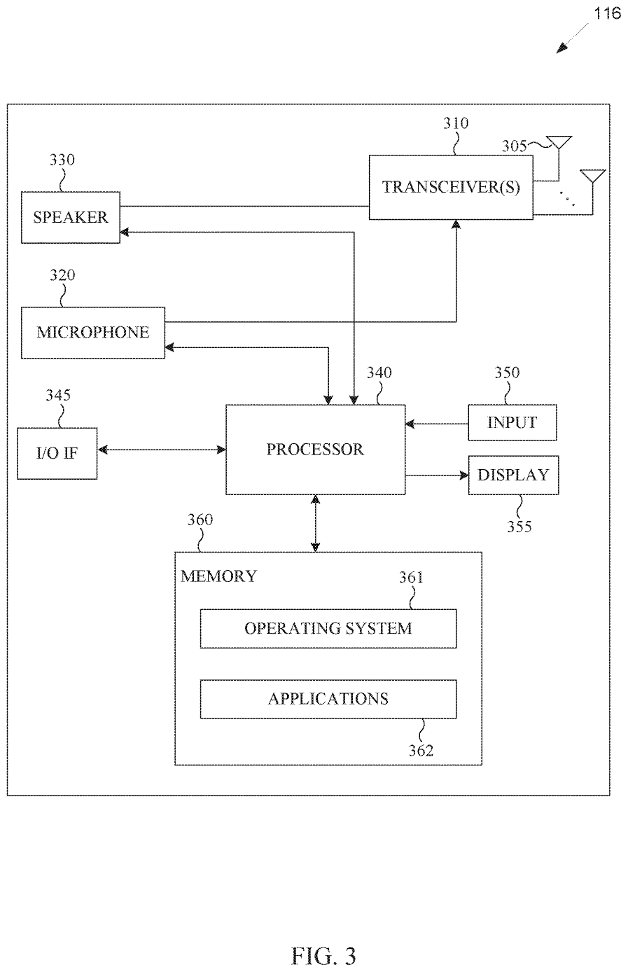

FIG. 3 illustrates an example UE 116 according to various embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a BS of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes to generate any signals and/or information for supporting an operation of a distributed MIMO calibration in a wireless communication system, at the BS 101-103, in a wireless communication system.

The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355m which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

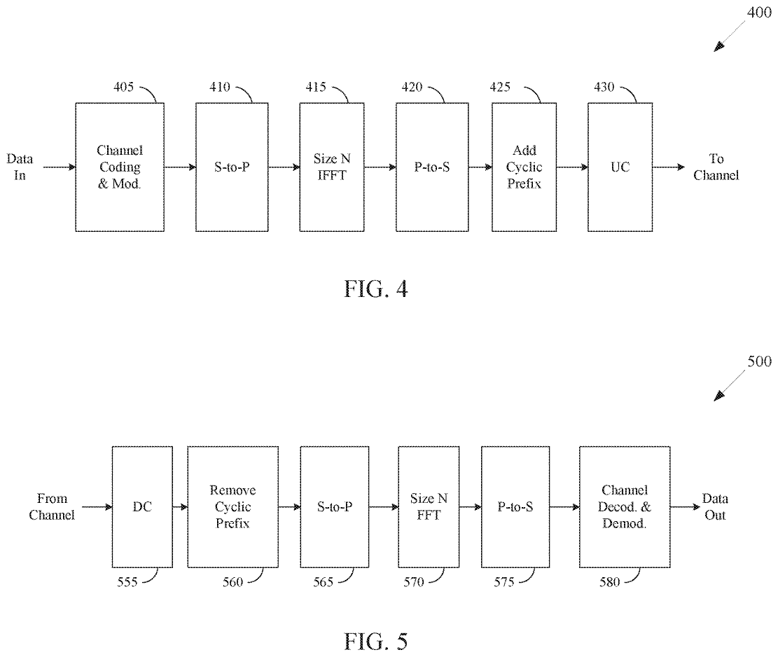

FIG. 4 and FIG. 5 illustrate examples of wireless transmit and receive paths according to various embodiments of the present disclosure. In the following description, a transmit path 400 may be described as being implemented in a BS (such as the BS 102), while a receive path 500 may be described as being implemented in a UE (such as a UE 116). However, it may be understood that the receive path 500 can be implemented in a BS and that the transmit path 400 can be implemented in a UE.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the BS 102 arrives at the UE 116 after passing through the wireless channel, and reverse operations to those at the BS 102 are performed at the UE 116.

As illustrated in FIG. 5, the downconverter 555 down-converts the received signal to a baseband frequency, and remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the BSs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the BSs 101-103 and may implement the receive path 500 for receiving in the downlink from the BSs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A unit for DL signaling or for UL signaling on a cell is referred to as a slot and can include one or more symbols. A bandwidth (BW) unit is referred to as a resource block (RB). One RB includes a number of sub-carriers (SCs). For example, a slot can have duration of one millisecond, and an RB can have a bandwidth of 180 KHz and include 12 SCs with inter-SC spacing of 15 KHz. A slot can be either a full DL slot, a full UL slot, or a hybrid slot similar to a special subframe in time division duplex (TDD) systems.

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. A UE can be indicated a spatial setting for a PDCCH reception based on a configuration of a value for a TCI state of a CORESET where the UE receives the PDCCH. The UE can be indicated a spatial setting for a PDSCH reception based on a configuration by higher layers or based on an indication by a DCI format scheduling the PDSCH reception of a value for a TCI state. The BS can configure the UE to receive signals on a cell within a DL bandwidth part (BWP) of the cell DL BW.

A BS transmits one or more multiple types of RS including reference signal (RS) CSI-RS (CSI-RS) and demodulation RS (DMRS). A CSI-RS is primarily intended for UEs to perform measurements and provide CSI to a BS. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process comprises NZP CSI-RS and CSI-IM resources. A UE can determine CSI-RS transmission parameters through DL control signaling or higher layer signaling, such as a radio resource control (RRC) signaling from a BS. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI demodulation, sounding RS (SRS) enabling a BS to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The BS can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, and CSI reports enabling a BS to select appropriate parameters for PDSCH or PDCCH transmissions to a UE. HARQ-ACK information can be configured to be with a smaller granularity than per TB and can be per data code block (CB) or per group of data CBs where a data TB includes a number of data CBs.

A CSI report from a UE can include a channel quality indicator (CQI) informing a BS of a largest MCS for the UE to detect a data TB with a predetermined block error rate (BLER), such as a 10% BLER, of a precoding matrix indicator (PMI) informing a BS how to combine signals from multiple transmitter antennas in accordance with a MIMO transmission principle, and of a rank indicator (RI) indicating a transmission rank for a PDSCH. UL RS includes DMRS and SRS. DMRS is transmitted only in a BW of a respective PUSCH or PUCCH transmission. A BS can use a DMRS to demodulate information in a respective PUSCH or PUCCH. SRS is transmitted by a UE to provide a BS with an UL CSI and, for a TDD system, an SRS transmission can also provide a PMI for DL transmission. Additionally, in order to establish synchronization or an initial higher layer connection with a BS, a UE can transmit a physical random-access channel.

In the present disclosure, a beam is determined by either of: (1) a TCI state, which establishes a quasi-colocation (QCL) relationship between a source reference signal (e.g., synchronization signal/physical broadcasting channel (PBCH) block (SSB) and/or CSI-RS) and a target reference signal; or (2) spatial relation information that establishes an association to a source reference signal, such as SSB or CSI-RS or SRS. In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE.

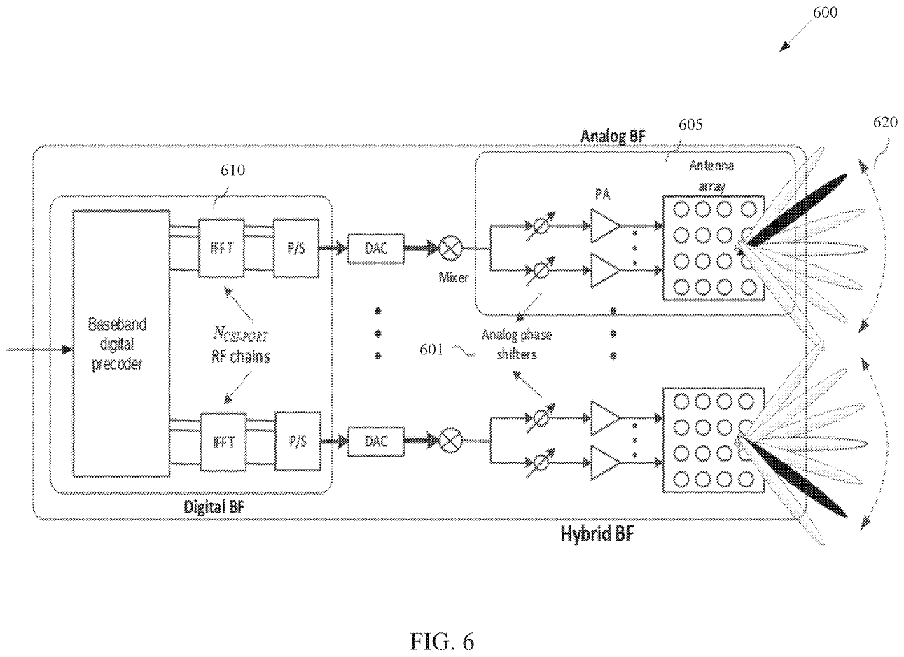

Rel.14 LTE and Rel.15 NR support up to 32 CSI-RS antenna ports which enable an eNB to be equipped with a large number of antenna elements (such as 64 or 128). In this case, a plurality of antenna elements is mapped onto one CSI-RS port. For mm Wave bands, although the number of antenna elements can be larger for a given form factor, the number of CSI-RS ports-which can correspond to the number of digitally precoded ports-tends to be limited due to hardware constraints (such as the feasibility to install a large number of ADCs/DACs at mmWave frequencies) as illustrated in FIG. 6.

FIG. 6 illustrates an example of antenna structure 600 according to various embodiments of the present disclosure. An embodiment of the antenna structure 600 shown in FIG. 6 is for illustration only.

In this case, one CSI-RS port is mapped onto a large number of antenna elements which can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase precoding gain. While analog beams are wideband (hence not frequency-selective), digital precoding can be varied across frequency sub-bands or resource blocks. Receiver operation can be conceived analogously.

Since the aforementioned system utilizes multiple analog beams for transmission and reception (wherein one or a small number of analog beams are selected out of a large number, for instance, after a training duration—to be performed from time to time), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting,” respectively), and receiving a DL or UL transmission via a selection of a corresponding RX beam.

The aforementioned system is also applicable to higher frequency bands such as >52.6 GHz. In this case, the system can employ only analog beams. Due to the O2 absorption loss around 60 GHz frequency (~10 dB additional loss at 100 m distance), larger number of and sharper analog beams (hence larger number of radiators in the array) may compensate for the additional path loss.

For a cellular system operating in a low carrier frequency in general, a sub-1 GHz frequency range (e.g., less than 1 GHz) as an example, supporting large number of CSI-RS antenna ports (e.g., 32) or many antenna elements at a single location or remote radio head (RRH) is challenging due to a larger antenna form factor size needed considering carrier frequency wavelength than a system operating at a higher frequency such as 2 GHz or 4 GHz. At such low frequencies, the maximum number of CSI-RS antenna ports that can be co-located at a site (or RRH) can be limited, for example to 8. This limits the spectral efficiency of such systems.

In particular, the MU-MIMO spatial multiplexing gains offered due to large number of CSI-RS antenna ports (such as 32) cannot be achieved due to the antenna form factor limitation. One way to operate a system with large number of CSI-RS antenna ports at low carrier frequency is to distribute the physical antenna ports to different panels/RRHs, which can be possibly non-collocated. The multiple sites or panels/RRHs can still be connected to a single (common) base unit forming a single antenna system, hence the signal transmitted/received via multiple distributed RRHs can still be processed at a centralized location.

The present disclosure provides a system called distributed MIMO, a multi-transmission-reception point (mTRP), or a coherent joint transmission (CJT)) and provides a method to perform calibration for the RF receive/transmit antenna network of multiple RRHs/panels in the system to utilize DL/UL channel reciprocity.

In one embodiment, an electronic devices and methods are provided for a calibration mechanism for (distributed) MIMO operations, more particularly, to electronic devices and methods on UE-assisted calibration mechanism in (distributed) MIMO of wireless networks.

Calibration is an important issue for distributed MIMO in general. Massive MIMO base stations use an on-board coupling network and calibration circuits, which will be referred to as the on-board calibration for brevity, to measure the gain and phase differences among transceivers in the same radio frequency (RF) unit in order to maintain the reciprocity between DL and UL channels in the TDD system. For the on-board calibration, one RF chain corresponding to one antenna port serves as a reference to other RF chains for other antenna ports. In the case of the distributed MIMO, such reference transceiver's signal may be shared between distributed RRHs/panels/modules, which are physically far apart.

Using RF cables to distribute the reference is not preferable as it limits the deployment scenarios. In the distributed MIMO, the use of different local oscillators (LOs) between distributed antenna modules imposes even more challenges in achieving calibration as the phase of LOs could drift. Periodic calibration may be used to compensate for the phase drift as well.

The present disclosure includes over-the-air (OTA) signaling mechanisms and calculation algorithms for calibration among the RRHs/panels of distributed MIMO networks. One of the provided mechanisms includes: (i) RS transmission from reference antenna port(s) and channel estimation at other ports; (ii) RS transmission from other ports and channel estimation at the reference ports; and (iii) deriving phase difference between all other ports and a common port using aforementioned channel estimations.

Providing an over-the-air (OTA) signaling mechanism including at least one of: (i) a reference signal (RS) transmission from a reference antenna port at a given radio unit (RU) and an associated channel estimation at one or more other ports at other RUs excluding the given RU; and/or (ii) an RS transmission from the one or more other ports at the other RUs and channel estimation at the reference antenna port, or 3) deriving phase difference among the one or more other ports and the reference antenna port using channel estimation.

Providing an over-the-air (OTA) signaling mechanism including at least one of: (i) a reference signal (RS) transmission from a reference antenna port at a different RU other than the given RU and an associated channel estimation at the one or more other ports at the given RU; (ii) a RS transmission from the one or more other ports at the given RU and channel estimation at the reference antenna port; and/or (iii) deriving phase difference among the one or more other ports at the given RU and the reference antenna port at the given RU using all channel estimation.

Multiplying, during downlink (DL) transmission, signals from each antenna port with a phase factor estimated with respect to the reference antenna port in the given RU to achieve coherent joint transmission.

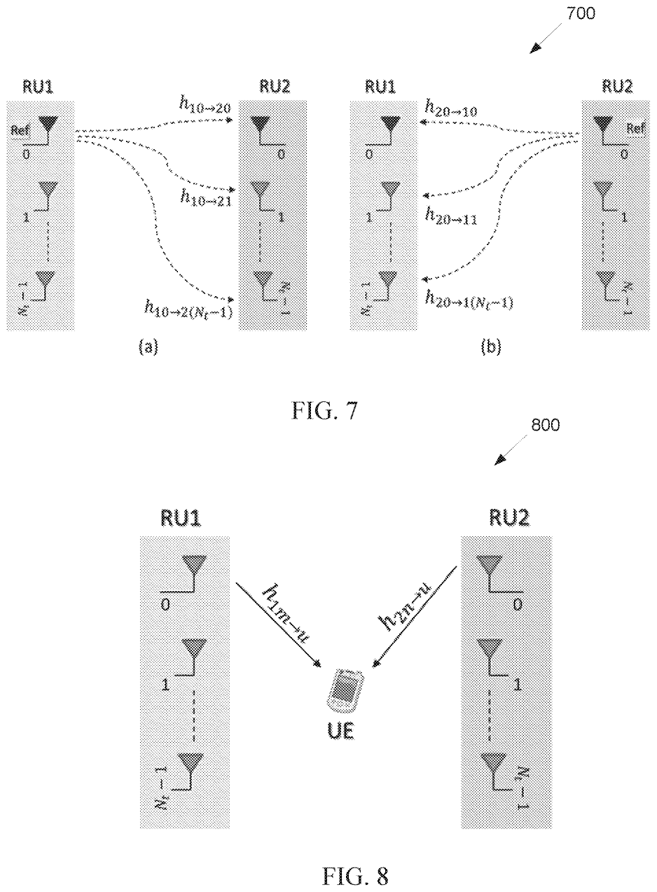

FIG. 7 illustrates an example of a transmission and reception of pilot 700 according to various embodiments of the present disclosure. An embodiment of the transmission and reception of pilot 700 shown in FIG. 7 is for illustration only.

FIG. 7 succinctly captures the operation scenario for provided D-MIMO calibration. It may be assumed that a transmission from m-th antenna port of i-th radio unit (RU) is to n-th antenna port of j-th RU. The channel for this transmission can be represented as, \tilde{h}_{im→jn}. With the associated transmitter and receiver RF impairments, this channel can be given as:

$${\tilde{h}}_{i m \to j n} = {h}_{i m \to j n} {e}^{j ( {θ}_{i m}^{T x} + {φ}_{j n}^{R x} )} \qquad ( 1 )$$

where, h_{im→jn} is the true channel between two antenna ports. Further,

$${θ}_{i m}^{T x} and {φ}_{j n}^{R x}$$

represent transmitter and receiver RF impairments, respectively.

FIG. 7 (e.g., (a) of FIG. 7) illustrates that antenna port 0 of RU1 acts as the reference port for transmitting and receiving pilots. FIG. 7 (e.g., (b) of FIG. 7) further illustrates that antenna port 0 of RU2 acts as the reference port for transmitting and receiving pilots. Channel measurements associated with these transmissions are subsequently used for estimating phase difference w.r.t. a common port.

In one example, given TDD systems with channel reciprocity, following holds:

h_{im→jn}=h_{jn→im} (2)

where, h_{jn→im} is the channel associated with transmission from n-th antenna port of j-th RU to m-th antenna port of i-th RU.

There are multiple steps involved in the calibration procedure. As illustrated in FIG. 7, a calibration procedure uses two reference ports from two RUs. The objective is to measure phase difference between each antenna port and a common antenna port,

$$( {θ}_{{p}^{*}}^{T x} - {φ}_{{p}^{*}}^{R x} ) - ( {θ}_{j n}^{T x} - {φ}_{j n}^{R x} )$$

where p* is the common antenna port. In one example, the provided calibration procedure can easily be extended for more than 2 RUs. In the example discussed next, p*=10 (0-th port in RU1) is considered as the common antenna port.

In one example of step 1, a pilot transmission is provided from antenna port 0 of RU1 as the reference port.

In one embodiment, antenna port 0 of RU1 is selected as the reference port. However, any antenna port from RU1 can be selected as the reference port. The reference port first acts as a transmitter and following channel measurements can be collected during the pilot transmission from antenna port 0 of RU1:

$${\tilde{h}}_{10 \to 20} = {h}_{10 \to 20} {e}^{j ( {θ}_{10}^{T x} + {φ}_{20}^{R x} )} \qquad ( 3 )$$

$${\tilde{h}}_{10 \to 21} = {h}_{10 \to 21} {e}^{j ( {θ}_{10}^{T x} + {φ}_{21}^{R x} )}$$

$$⋮$$

$${\tilde{h}}_{10 \to 2 ( {N}_{t} - 1 )} = {h}_{10 \to 2 ( {N}_{t} - 1 )} {e}^{j ( {θ}_{10}^{T x} + {φ}_{2 ( {N}_{t} - 1 )}^{R x} )}$$

In one embodiment of step 2, a pilot reception is provided from antenna port 0 of RU1 as the reference port. Afterwards, antenna port 0 of RU1 acts as a receiver and another set of channel measurement can be collected as follows:

$${\tilde{h}}_{20 \to 10} = {h}_{20 \to 10} {e}^{j ( {θ}_{20}^{T x} + {φ}_{10}^{R x} )} \qquad ( 4 )$$

$${\tilde{h}}_{21 \to 10} = {h}_{21 \to 10} {e}^{j ( {θ}_{21}^{T x} + {φ}_{10}^{R x} )}$$

$$⋮$$

$${\tilde{h}}_{2 ( {N}_{t} - 1 ) \to 10} = {h}_{2 ( {N}_{t} - 1 ) \to 10} {e}^{j ( {θ}_{2 ( {N}_{t} - 1 )}^{T x} + {φ}_{10}^{R x} )}$$

Now, by taking the ratio between \tilde{h}_{10→2n} and \tilde{h}_{2n→10}, n∈{0, . . . (Nₜ−1)},

$${α}_{2 n}^{10}$$

can be derived as:

$${α}_{2 n}^{10} = \frac{{\tilde{h}}_{10 \to 2 n}}{{\tilde{h}}_{2 n \to 10}} = {e}^{j [ ( {θ}_{10}^{T x} - {φ}_{10}^{R x} ) - ( {θ}_{2 n}^{T x} - {φ}_{2 n}^{R x} ) ]} \qquad ( 5 )$$

In one example, as per (2), h_{10→2n}=h_{2n→10} and hence those terms are getting cancelled when calculating the ratio in equation (5).

With equation (5), a phase difference between the common port, p*=10 and each port in RU2 can be quantified. However, the phase difference between the common port and all other ports in the same RU (RU1 in the example) is not possible to quantify with these measurements. Hence, in another embodiment, antenna port 0 of RU2 also acts as a reference port for collecting additional measurements as discussed next, to quantify intra RU phase differences w.r.t. the common port.

In one embodiment of Step 3, a pilot transmission is provided from antenna port 0 of RU2 as the reference port. Antenna port 0 of RU2 first acts as a transmitter and following channel measurements can be collected during the pilot transmission:

$${\tilde{h}}_{20 \to 11} = {h}_{20 \to 11} {e}^{j ( {θ}_{20}^{T x} + {φ}_{11}^{R x} )} \qquad ( 6 )$$

$$⋮$$

$${\tilde{h}}_{20 \to 1 ( {N}_{t} - 1 )} = {h}_{20 \to 1 ( {N}_{t} - 1 )} {e}^{j ( {θ}_{20}^{T x} + {φ}_{1 ( {N}_{t} - 1 )}^{R x} )}$$

In one embodiment of Step 4, a pilot reception is provided from antenna port 0 of RU2 as the reference port.

Finally, antenna port 0 of RU2 acts as a receiver and another set of channel measurements can be collected as follows:

$${\tilde{h}}_{11 \to 20} = {h}_{11 \to 20} {e}^{j ( {θ}_{11}^{T x} + {φ}_{20}^{R x} )} \qquad ( 7 )$$

$$⋮$$

$${\tilde{h}}_{1 ( {N}_{t} - 1 ) \to 20} = {h}_{1 ( {N}_{t} - 1 ) \to 20} {e}^{j ( {θ}_{1 ( {N}_{t} - 1 )}^{T x} + {φ}_{20}^{R x} )}$$

Given additional measurements in equation (6) and equation (7), a phase differences between each antenna port in RU1 and antenna port 0 of RU2 (ref. port) can be calculated by taking the ratio between \tilde{h}_{20→1m} and \tilde{h}_{1m→20}, m∈{1, . . . (Nₜ−1)} as:

$${α}_{1 m}^{20} = \frac{{\tilde{h}}_{20 \to 1 m}}{{\tilde{h}}_{1 m \to 20}} = {e}^{j [ ( {θ}_{20}^{T x} - {φ}_{20}^{R x} ) - ( {θ}_{1 m}^{T x} - {φ}_{1 m}^{R x} ) ]} \qquad ( 8 )$$

Subsequently, using equation (8) and equation (5), a phase difference between each antenna port in RU1 (except port 0) and antenna port 0 of RU1 (common port) can be derived as follows:

$${α}_{1 m}^{10} = {α}_{20}^{10} \times {α}_{1 m}^{20} = \frac{{\tilde{h}}_{10 \to 20}}{{\tilde{h}}_{20 \to 10}} \times \frac{{\tilde{h}}_{20 \to 1 m}}{{\tilde{h}}_{1 m \to 20}} = {e}^{j [ ( {θ}_{10}^{T x} - {φ}_{10}^{R x} ) - ( {θ}_{20}^{T x} - {φ}_{20}^{R x} ) ]} \times {e}^{j [ ( {θ}_{20}^{T x} - {φ}_{20}^{R x} ) - ( {θ}_{1 m}^{T x} - {φ}_{1 m}^{R x} ) ]} = {e}^{j [ ( {θ}_{10}^{T x} - {φ}_{10}^{R x} ) - ( {θ}_{1 m}^{T x} - {φ}_{1 m}^{R x} ) ]} \qquad ( 9 )$$

With equation (5) and equation (9), a phase difference between each antenna port in the D-MIMO system and common port is readily available which can then be used for phase calibration to achieve coherent joint transmission, as discussed next.

FIG. 8 illustrates an example of coherent JT to a UE from two RUs 800 according to various embodiments of the present disclosure. An embodiment of the coherent JT to a UE from two RUs 800 shown in FIG. 8 is for illustration only.

As illustrated in FIG. 8, the true channel between u-th UE and m-th antenna port of i-th RU be, h_{u→im}=h_{im→u}. Further, let the estimated channel between u-th UE and m-th antenna port of i-th RU during sounding reference signal (SRS) transmission be, \tilde{h}_{u→im}. Then \tilde{h}_{u→im} can be given as:

$${\tilde{h}}_{u \to im} = {h}_{u \to im} {e}^{j ( {φ}_{i m}^{R x} )} . \qquad ( 10 )$$

Subsequently, estimated channel in equation (10) can be considered along with the phase calibration factor estimated using equation (5) and equation (9), to derive DL conjugate beamforming p_{im→u} as follows:

$${p}_{i m \to u} = {α}_{i m}^{10} \times {( {\tilde{h}}_{u \to im} )}^{*} \qquad ( 11 )$$

Then, the gain observed at the UE during the transmission from m-th antenna port of i-th RU can be given as:

$${g}_{i m \to u} = {p}_{i m \to u} {e}^{j ( {θ}_{i m}^{T x} )} {h}_{u \to i m} = {α}_{i m}^{10} \times {( {\tilde{h}}_{u \to i m} )}^{*} {e}^{j ( {θ}_{i m}^{T x} )} {h}_{u \to i m} = {α}_{i m}^{10} \times {\vert {\tilde{h}}_{u \to im} \vert}^{2} {e}^{j ( {θ}_{i m}^{T x} - {φ}_{i m}^{R x} )} = {e}^{j [ ( {θ}_{10}^{T x} - {φ}_{10}^{R x} ) - ( {θ}_{i m}^{T x} - {φ}_{i m}^{R x} ) ]} \times {\vert {\tilde{h}}_{u \to im} \vert}^{2} {e}^{j ( {θ}_{i m}^{T x} - {φ}_{i m}^{R x} )} = {\vert {\tilde{h}}_{u \to im} \vert}^{2} \times {e}^{j [ ( {θ}_{10}^{T x} - {φ}_{10}^{R x} ) ]} \qquad ( 12 )$$

With constant phase difference across all antenna ports, coherent joint transmission can be guaranteed.

In one embodiment, the two reference antennas can be selected arbitrarily. One possible criterion to pick reference antennas is based on the received signal strength. In another embodiment, it is possible to have both the reference antennas on the same RU as well.

Further, there will be multiple measurements available during pilot transmissions. For example, when antenna port 0 of RU1 acts as a receiver, all other antenna ports in the same RU can receive those pilot transmissions. On the other hand, when antenna port 0 of RU2 receives pilot transmissions, all other ports in the same RU can receive those pilot transmissions. In one embodiment, all these measurements can be effectively utilized to enhance the accuracy of phase measurements by achieving a better noise tolerance.

In another embodiment, this D-MIMO calibration procedure can be easily extended to more than 2 RUs.

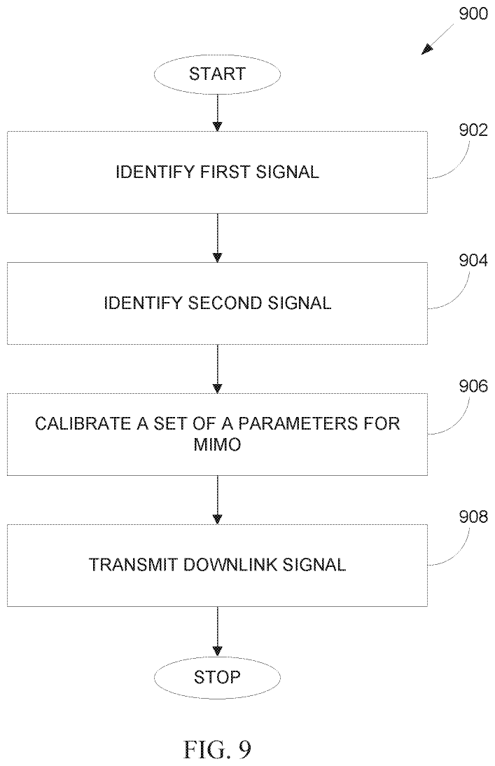

FIG. 9 illustrates a flowchart of a BS method 900 for a distributed MIMO calibration according to various embodiments of the present disclosure. The method 900 may be performed by a BS (e.g., 101-103 as illustrated in FIG. 1). An embodiment of the method 900 shown in FIG. 9 is for illustration only. One or more of the components illustrated in FIG. 9 can be implemented in specialized circuitry configured to perform the noted functions or one or more of the components can be implemented by one or more processors executing instructions to perform the noted functions.

As illustrated in FIG. 9, in step 902, the BS begins identifies first signals comprising a first set of the first signals and a second set of the first signals. In step 902, the first set of the first signals comprises an RS received from a reference antenna port included in the network entity and channel estimate identified from antenna ports included in a neighbor network entity, and the second set of the first signals comprises an RS received from the antenna ports included in the neighbor network entity and channel estimate identified from the reference antenna port included in the network entity.

Subsequently, the BS in step 904 identifies second signals comprising a first set of the second signals and a second set of the second signals. In step 904, the first set of the second signals comprises an RS received from a reference antenna port included in the neighbor network entity and channel estimate identified from antenna ports included in the network entity, and the second set of the second signals comprises an RS received from the antenna ports included in the network entity and channel estimate identified from the reference antenna port included in the neighbor network entity.

Next, in step 906, the BS calibrates, based on the first signals and the second signals, a set of parameters for a distributed MIMO to transmit downlink signals.

Finally, in step 908, the BS transmits, to a UE, the downlink signals.

In one embodiment, a first set of antenna ports includes the reference antenna port and the antenna ports include in the network entity and a second set of antenna ports includes the reference antenna port and the antenna ports included in the neighbor network entity.

In one embodiment, the BS multiplies, based on a phase factor, signals received from each antenna port of the first set of antenna ports for a coherent joint transmission, the phase factor being identified based on the reference antenna port included in the network entity.

In one embodiment, the BS identifies a phase difference between the antenna ports included in the neighbor network entity and the reference antenna port used to identify the channel estimate in the network entity.

In one embodiment, the BS identifies a phase difference between the antenna ports included in the network entity and the reference antenna port used to identify the channel estimate in the neighbor network entity.

In one embodiment, the BS performs an inter-network entity calibration to identify inter-network entity calibration factors and perform an intra-network entity calibration to identify intra-network entity calibrations factors.

In one embodiment, the BS, for the inter-network entity calibration, identifies a transmission of a pilot signal from the reference antenna port included in the network entity; and identifies a reception of a pilot signal at the reference antenna port included in the network entity.

In one embodiment, the BS performs a transmission channel measurement operation during transmitting the pilot signal in the network entity; performs a reception channel measurement operation during receiving the pilot signal in the network entity; and identifies, based on a ratio between the transmission and reception channel measurement operation, inter-network entity calibration factors.

In one embodiment, the BS, for the intra-network entity calibration: identifies a transmission of a pilot signal from the reference antenna port included in the neighbor network entity; and identifies a reception of a pilot signal at the reference antenna port included in the neighbor network entity.

In one embodiment, the BS performs a transmission channel measurement operation during transmitting the pilot signal in the neighbor network entity; performs a reception channel measurement operation during receiving the pilot signal in the neighbor network entity; and identifies, based on a ratio between the transmission and reception channel measurement operation and inter-network entity calibration factors, intra-network entity calibration factors.

In one embodiment, the BS performs, based on the set of calibrated parameters for the distributed MIMO, a coherent joint transmission with the neighbor network entity.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the claims appended. None of the description in this application should be read as implying that any particular element, step, or function is an essential element that must be included in the claims scope. The scope of patented subject matter is defined by the claims.

What is claimed is:

1. A network entity in a wireless communication system, the network entity comprising:
a processor configured to:
identify first signals comprising a first set of the first signals and a second set of the first signals, wherein:
the first set of the first signals comprises a reference signal (RS) received from a reference antenna port included in the network entity and channel estimate identified from antenna ports included in a neighbor network entity, and
the second set of the first signals comprises an RS received from the antenna ports included in the neighbor network entity and channel estimate identified from the reference antenna port included in the network entity,
identify second signals comprising a first set of the second signals and a second set of the second signals, wherein:
the first set of the second signals comprises an RS received from a reference antenna port included in the neighbor network entity and channel estimate identified from antenna ports included in the network entity, and
the second set of the second signals comprises an RS received from the antenna ports included in the network entity and channel estimate identified from the reference antenna port included in the neighbor network entity,
calibrate, based on the first signals and the second signals, a set of parameters for a distributed multi-input multi-output (MIMO) to transmit downlink signals; and
a transceiver operably coupled to the processor, the transceiver configured to transmit, to a user equipment (UE), the downlink signals,
wherein a first set of antenna ports includes the reference antenna port and the antenna ports include in the network entity and a second set of antenna ports includes the reference antenna port and the antenna ports included in the neighbor network entity.

2. The network entity of claim 1, wherein the processor is further configured to multiply, based on a phase factor, signals received from each antenna port of the first set of antenna ports for a coherent joint transmission, the phase factor being identified based on the reference antenna port included in the network entity.

3. The network entity of claim 1, wherein the processor is further configured to identify a phase difference between the antenna ports included in the neighbor network entity and the reference antenna port used to identify the channel estimate in the network entity.

4. The network entity of claim 1, wherein the processor is further configured to identify a phase difference between the antenna ports included in the network entity and the reference antenna port used to identify the channel estimate in the neighbor network entity.

5. The network entity of claim 1, wherein the processor is further configured to perform an inter-network entity calibration to identify inter-network entity calibration factors and perform an intra-network entity calibration to identify intra-network entity calibrations factors.

6. The network entity of claim 5, wherein, for the inter-network entity calibration, the processor is further configured to:
identify a transmission of a pilot signal from the reference antenna port included in the network entity; and
identify a reception of a pilot signal at the reference antenna port included in the network entity.

7. The network entity of claim 6, wherein the processor is further configured to:
perform a transmission channel measurement operation during transmitting the pilot signal in the network entity;
perform a reception channel measurement operation during receiving the pilot signal in the network entity; and
identify, based on a ratio between the transmission and reception channel measurement operation, inter-network entity calibration factors.

8. The network entity of claim 5, wherein, for the intra-network entity calibration, the processor is further configured to:
identify a transmission of a pilot signal from the reference antenna port included in the neighbor network entity; and
identify a reception of a pilot signal at the reference antenna port included in the neighbor network entity.

9. The network entity of claim 8, wherein the processor is further configured to:
perform a transmission channel measurement operation during transmitting the pilot signal in the neighbor network entity;
perform a reception channel measurement operation during receiving the pilot signal in the neighbor network entity; and
identify, based on a ratio between the transmission and reception channel measurement operation and inter-network entity calibration factors, intra-network entity calibration factors.

10. The network entity of claim 1, wherein the processor is further configured to perform, based on the set of calibrated parameters for the distributed MIMO, a coherent joint transmission with the neighbor network entity.

11. A method of a network entity in a wireless communication system, the method comprising:
identifying first signals comprising a first set of the first signals and a second set of the first signals, wherein:
the first set of the first signals comprises a reference signal (RS) received from a reference antenna port included in the network entity and channel estimate identified from antenna ports included in a neighbor network entity, and
the second set of the first signals comprises an RS received from the antenna ports included in the neighbor network entity and channel estimate identified from the reference antenna port included in the network entity;
identifying second signals comprising a first set of the second signals and a second set of the second signals, wherein:
the first set of the second signals comprises an RS received from a reference antenna port included in the neighbor network entity and channel estimate identified from antenna ports included in the network entity, and
the second set of the second signals comprises an RS received from the antenna ports included in the network entity and channel estimate identified from the reference antenna port included in the neighbor network entity;
calibrating, based on the first signals and the second signals, a set of parameters for a distributed multi-input multi-output (MIMO) to transmit downlink signals; and
transmitting, to a user equipment (UE), the downlink signals,
wherein a first set of antenna ports includes the reference antenna port and the antenna ports include in the network entity and a second set of antenna ports includes the reference antenna port and the antenna ports included in the neighbor network entity.

12. The method of claim 11, further comprising multiplying, based on a phase factor, signals received from each antenna port of the first set of antenna ports for a coherent joint transmission, the phase factor being identified based on the reference antenna port included in the network entity.

13. The method of claim 11, further comprising identifying a phase difference between the antenna ports included in the neighbor network entity and the reference antenna port used to identify the channel estimate in the network entity.

14. The method of claim 11, further comprising identifying a phase difference between the antenna ports included in the network entity and the reference antenna port used to identify the channel estimate in the neighbor network entity.

15. The method of claim 11, further comprising performing an inter-network entity calibration to identify inter-network entity calibration factors and perform an intra-network entity calibration to identify intra-network entity calibrations factors.

16. The method of claim 15, further comprising, for the inter-network entity calibration:
identifying a transmission of a pilot signal from the reference antenna port included in the network entity; and
identifying a reception of a pilot signal at the reference antenna port included in the network entity.

17. The method of claim 16, further comprising:
performing a transmission channel measurement operation during transmitting the pilot signal in the network entity;
performing a reception channel measurement operation during receiving the pilot signal in the network entity; and
identifying, based on a ratio between the transmission and reception channel measurement operation, inter-network entity calibration factors.

18. The method of claim 15, further comprising, for the intra-network entity calibration:
identifying a transmission of a pilot signal from the reference antenna port included in the neighbor network entity; and
identifying a reception of a pilot signal at the reference antenna port included in the neighbor network entity.

19. The method of claim 18, further comprising:
performing a transmission channel measurement operation during transmitting the pilot signal in the neighbor network entity;
performing a reception channel measurement operation during receiving the pilot signal in the neighbor network entity; and
identifying, based on a ratio between the transmission and reception channel measurement operation and inter-network entity calibration factors, intra-network entity calibration factors.

20. The method of claim 11, further comprising performing, based on the set of calibrated parameters for the distributed MIMO, a coherent joint transmission with the neighbor network entity.
